(19) United States
(12) Patent Application Publication
(10) Pub. No.: US 2026/0154395 A1
(43) Pub. Date: Jun. 4, 2026

(54) MICROCONTROLLER AND METHOD FOR CONFIGURING

(71) Applicant: STMicroelectronics International N. V., Geneva (CH)

(72) Inventor: Jawad Benhammadi, Pont de Claix (FR)

(21) Appl. No.: 19/376,078

(22) Filed: Oct. 31, 2025

(30) Foreign Application Priority Data
Nov. 29, 2024 (FR) FR2413245

(51) Int. Cl. G06F 21/44; G06F 9/30; G06F 21/57

(52) U.S. Cl. CPC G06F 21/44; G06F 9/30098; G06F 21/57

(57) ABSTRACT

The present disclosure relates to a method for configuring a microcontroller, comprising authorizing modification of a register containing microcontroller configuration option bytes if a first stage of start-up program of the microcontroller, secured by the microcontroller manufacturer, is run; and if a microcontroller program access authorization level corresponds to a microcontroller manufacturing state or a state where only a first stage of startup program of the microcontroller is authorized.

### CROSS-REFERENCE TO RELATED APPLICATIONS

This application claims priority to French Application No. 2413245, filed on November 29, 2024, which application is hereby incorporated herein by reference.

### TECHNICAL FIELD

The present disclosure generally relates to methods for configuring microcontrollers and to microcontrollers implementing these methods.

### BACKGROUND

Modifying security parameters of present day microcontrollers can only be performed during manufacturing steps, either by the manufacturer or by a subcontractor.

### SUMMARY

There is a need to be able to modify the configuration of microcontrollers after they have been manufactured, and in particular their security parameters or available memory sizes.

One or more embodiments overcome some or all of the drawbacks of known configuration methods.

One embodiment provides a method for configuring a microcontroller, comprising authorizing modification of a register containing microcontroller configuration option bytes if: a first stage of the startup program of the microcontroller, secured by the microcontroller manufacturer, is run; and an access authorization level of the microcontroller program corresponds to a microcontroller manufacturing state or a state where only a first stage of the startup program of the microcontroller is authorized.

According to one embodiment, a first program, secured by the microcontroller manufacturer, is read by the first stage of start-up program and, if authorization has been validated, the value of one or more option bytes in the register is modified according to instructions included in the first program.

According to one embodiment, the first stage of start-up program is stored in a FLASH-type system memory of the microcontroller.

According to one embodiment, when the first stage of start-up program is run, a first signal is set to a given value.

According to one embodiment, the first signal is set to a value of 0xA3 when the first stage of start-up program is run.

According to one embodiment, the program access authorization level of the microcontroller is given by a monotonically increasing counter.

According to one embodiment, the zero value of the monotonic counter corresponds to the state where the microcontroller is in production.

According to one embodiment, the value 1 of the monotonic counter corresponds to the state where only the first stage of start-up program is authorized.

According to one embodiment, modification of option bytes is authorized if the first signal has the given value and the monotonic counter has the value zero or the value 1.

According to one embodiment, the first stage of start-up program of the microcontroller and the first program are secured with one or more security keys.

According to one embodiment, the register comprises several categories of different option bytes for controlling the activation or deactivation of the same microcontroller configuration characteristic; a first category of option bytes being writable only during a production phase by the microcontroller manufacturer; and a second category of option bytes being writable, after production, if the authorization is validated.

According to one embodiment, prior to the authorization step, the first program is loaded into a download memory of the microcontroller.

According to one embodiment, after loading the first program, the microcontroller is reset.

According to one embodiment, the one or more option byte values that have been modified are reset, after a given time, to their value before modification.

One or more embodiments provide a microcontroller, comprising a configuration option byte register, and configured to implement the method for configuring described above.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 illustrates very schematically, in block form, an example microcontroller of the type to which the described embodiments apply;

FIG. 2 illustrates a method for configuring the microcontroller shown in FIG. 1; and

FIG. 3 illustrates a step in the method shown in FIG. 2.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms "front", "back", "top", "bottom", "left", "right", etc., or to relative positional qualifiers, such as the terms "above", "below", "higher", "lower", etc., or to qualifiers of orientation, such as "horizontal", "vertical", etc., reference is made to the orientation shown in the figures.

Unless specified otherwise, the expressions "around", "approximately", “substantially” and "in the order of" signify within 10% or 10°, and preferably within 5% or 5°.

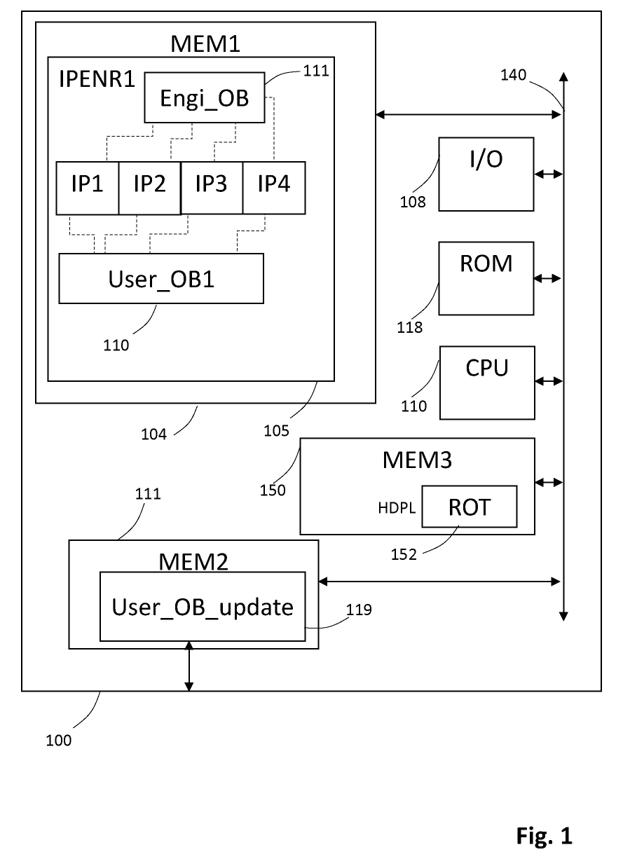

FIG. 1 illustrates very schematically, in block form, an example microcontroller 100 of the type to which the described embodiments apply.

In the example illustrated, the microcontroller 100 comprises a memory 104 (MEM1), for example a non-volatile memory (NVM) of the FLASH- or phase-change-memory (PCM) type, capable of communicating, via a communication bus, with a non-volatile memory interface not illustrated, configured to write or read data to and from memory 104.

The microcontroller 100 further comprises, for example, a processing unit 110 (CPU) comprising one or more processors under the control of instructions stored in an instruction memory not illustrated, which is, for example, a volatile Random Access Memory (RAM).

The processing unit 110 and the instruction memory communicate, for example, via a system bus 140 (data, address, and control). The memory 104 is coupled to the system bus 140, for example via a memory interface not illustrated and via an intermediate bus not illustrated. The microcontroller 100 further comprises, for example, an input/output (I/O) interface 108 coupled to the system bus 140 for external communication.

In the example illustrated, memory 104 comprises a register 105 of options for configuring the microcontroller IPENR1. Register 105 is, for example, 32 bits long. The content of register 105 controls possible configurations IP1, IP2, IP3, IP4, etc. of microcontroller 100. These configurations are, for example, security configurations such as those related to cryptography, e.g. hardware accelerators SAES, CRYP, MCE, CCB, or RNG. These configurations are, for example, configurations linked to available memory size. For example, depending on the register bit value, the non-volatile memory available can thus range from 4 MB to 512 KB. Configurations IP1, IP2, IP3, IP4... can also relate to parameters such as CAN, LCD, JPEG, or HCD.

Each of the configurations can be activated or deactivated as a function of option byte values in a register 110 (User_OB1) which can be modified, for example, by a subcontractor. Each of the configurations can also be activated or deactivated according to the content of another option byte register 111 (Engi_OB), which can be modified, for example, only during production of the microcontroller 100.

For example, the microcontroller 100 comprises a memory 150 (MEM3), e.g. non-volatile, of the FLASH- or phase-change-type. Memory 150 is, for example, the same as memory 104. Memory 150 communicates with the other elements of microcontroller 100, for example, via system bus 140. Memory 150 is, for example, a system memory, i.e. it contains, for example, memory sectors that can only be accessed by the manufacturer of microcontroller 100. For example, memory 150 thus comprises a start-up program 152, root of trust, (ROT) for the microcontroller, which cannot be updated after manufacture. This is an immutable root of trust program, for example, which is run first after a reset of the microcontroller 100. Program 152 has an access authorization level HDPL, which is associated, for example, with an increasing monotonic counter. For example, the access authorization level takes on a value HDPL=HDPL0=0 when the microcontroller 100 is in production. When the microcontroller 100 is in a state where only a first stage of the start-up program of microcontroller is authorized, then HDPL=HDPL1=1 for example. When HDPL=HDPL1=1, then in an example, only program 152 ROT is run. The HDPL=HDPL1=1 state is reached as soon as the microcontroller is at a customer or subcontractor site.

For example, the microcontroller 100 comprises a memory 111 (MEM2), e.g. non-volatile, of the FLASH- or phase-change-type. Memory 111 is, for example, the same as memory 104 or memory 150. Memory 210 communicates with the other elements of microcontroller 100, for example, via system bus 140. Memory 210 comprises, for example, memory locations 119 configured to receive elements (User_OB_update) received during updates. These elements received during updates are, for example, program images (such as .bin files).

The microcontroller 100 may incorporate other circuits implementing other functions (for example, one or more volatile and/or non-volatile memories, or other processing units), not illustrated in FIG. 1. Among these other circuits, the microcontroller 100 includes, for example, a read-only or static memory 118 (ROM).

The example shown in FIG. 1 is limited in terms of modifying configurations IP1, IP2, IP3, IP4.... Indeed, at present, only the manufacturer or a subcontractor can modify these configurations, which may concern safety parameters. Once the microcontroller 100 has been put up for sale, and is no longer with the manufacturer or subcontractor, the registers USER_OB1 and Engi_OB can no longer be modified, which prevents any further modification of the configurations IP1, IP2, IP3, IP4….

The described embodiments overcome these drawbacks by providing a method for configuring the microcontroller 100, comprising modifying a register containing microcontroller configuration option bytes (User_OB1) if: a first stage of a start-up program (ROT) of the microcontroller (100), secured by the microcontroller manufacturer, is run; and a level of access authorization of the microcontroller program corresponds to a state among microcontroller manufacturing (HDPL0), or to a state where only a first program stage of the microcontroller startup (HDPL1) is authorized.

This solution allows the modification of option bytes User_OB1 to be authorized and carried out, under certain defined conditions and under the manufacturer's control, even after manufacture, and even when the microcontroller 100 is at the end-user site.

Such a solution allows configurations IP1, IP2, IP3, IP4 to be modified, under the manufacturer's control, once the microcontroller 100 has been sold or is no longer with the manufacturer or subcontractor. This allows throughout the microcontroller lifetime, configurations of the microcontroller 100 that are not activated when it leaves the factory, for example when paying for an upgrade, to be activated. This further allows the microcontroller manufacturer having control over configuration changes, including, for example, security parameters on the microcontroller 100.

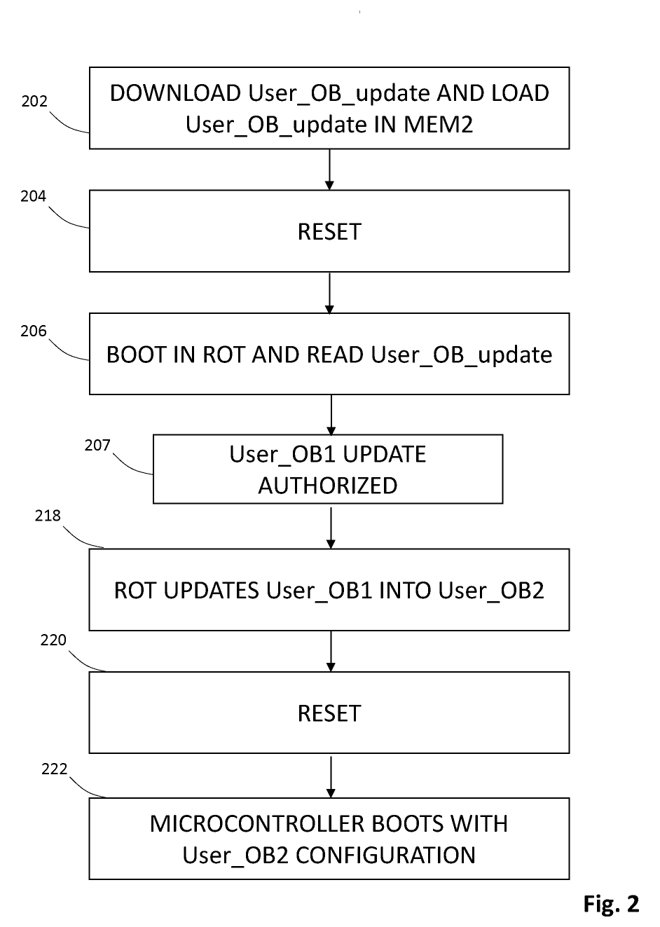

FIG. 2 illustrates a method for configuring the microcontroller shown in FIG. 1.

In a step 202 (DOWNLOAD User_OB_update AND LOAD User_OB_update IN MEM2), a program User_OB_update is downloaded and stored in memory space 119. The program User_OB_update comprises, for example, instructions to update the option bytes User_OB_update in register 110, and to reset microcontroller 100. The program User_OB_update is, for example, in the form of one or more images.

In a step 204 (RESET), subsequent to step 302, the microcontroller 100 is reset.

In a step 206 (BOOT IN ROT AND READ User_OB_update), subsequent to step 204, the microcontroller 100 starts up by executing the program ROT, which is the first stage of the startup program that reads the instructions present in the program User_OB_update.

In a step 207 (User_OB1 UPDATE AUTHORIZED), subsequent to step 206, authorization is obtained to make register 110 accessible and writable, so that the option bytes (User_OB1) can be updated. This authorization originates, for example, from the end-user paying the manufacturer for an upgrade, e.g. a microcontroller professional or subcontractor.

In a step 218 (ROT UPDATES User_OB1 INTO User_OB2), subsequent to step 207, the option bytes User_OB1 are modified and a new version of the option bytes, called User_OB2, is obtained in register 110. The configurations IP1, IP2, IP3, IP4... are thus modified according to the contents of the respective option bytes User_OB2.

In a step 220 (RESET), subsequent to step 218, the microcontroller 100 is reset.

In a step 222 (MICROCONTROLLER BOOTS WITH User_OB2 CONFIGURATION), subsequent to step 220, the microcontroller 100 is reset again to restart the microcontroller 100 with the new configurations enabled by the option bytes User_OB2.

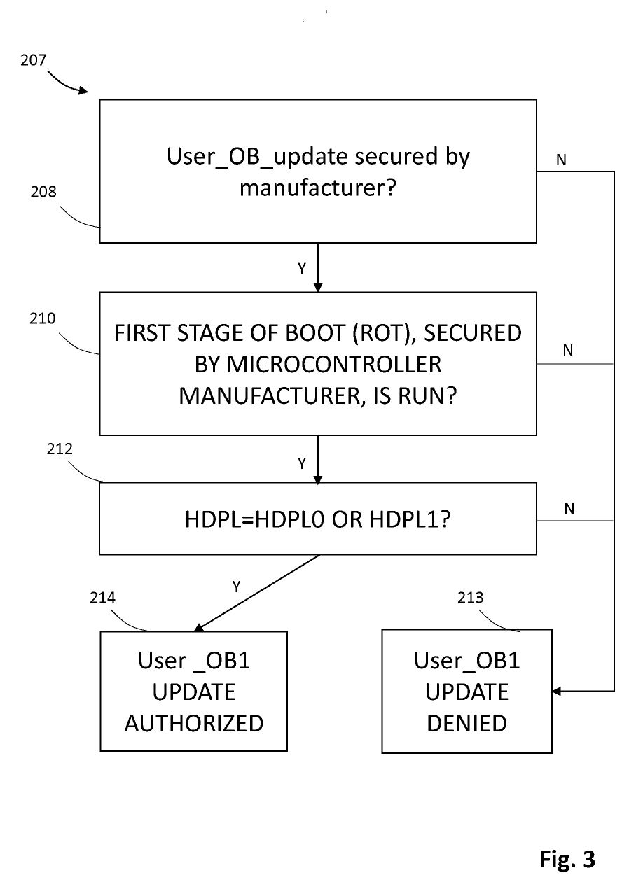

So that the manufacturer can maintain control over configuration updates to the microcontroller 100 after manufacture, step 207 contains specific features developed in FIG. 3.

FIG. 3 illustrates a step in the method shown in FIG. 2. In particular, FIG. 3 illustrates in detail an example implementation of step 207.

In the example shown in FIG. 3, step 207 comprises, for example, several intermediate steps 208, 210, 212, and 214.

In step 208 (User_OB_update secured by manufacturer?), it is checked, for example with the program ROT, whether the program User_OB_update is secured by the microcontroller manufacturer. In one example, the program User_OB_update is considered secured by manufacturer if one or more security keys supplied by the microcontroller manufacturer are used to, for example, sign the program. If the program User_OB_update is recognized as secure (branch Y), then one of steps 210 or 212 is implemented next. If not (branch N), then a step 213 (User_OB1 UPDATE DENIED) is implemented.

In step 213, access to modify option byte values User_OB1 is denied.

In step 210 (FIRST STAGE OF BOOT (ROT), SECURED BY MICROCONTROLLER MANUFACTURER, IS RUN?), it is checked whether the program that forms the first stage of start-up, for example the program ROT, is secured by the manufacturer of the microcontroller 100 and is run. To do this, in one example, when the first stage of the start-up program ROT is secured and run, then a first signal RSSACCDIS is set to a given value. In one example, the first signal RSSACCDIS is set to the value 0xA3 when the first stage of the startup program ROT is secured and run. Thus, by checking the value of the first signal, it is possible to know directly whether the program being run is the start-up program secured by the manufacturer, or whether the program being run is another program, for example not secured by the manufacturer. If the program which constitutes the first start-up stage, for example the program ROT, is secured by the manufacturer of the microcontroller 100 and is run, then (branch Y) one of steps 208 or 212 is implemented. Otherwise (branch N), step 213 (User_OB1 UPDATE DENIED) is implemented.

In step 212 (HDPL=HDPL0 OR HDPL1?), if the monotonic counter HDPL has the value zero or the value 1, i.e. HDPL0, HDPL1, then (branch Y) step 214 (User_OB1_UPDATE AUTHORIZED) is implemented. If HDPL has a value other than the value zero or the value 1, i.e. other than HDPL0 or HDPL1, then step 213 is implemented.

In step 214, modifying the option bytes User_OB1 is authorized. In the example illustrated, steps 208, 210, and 212 follow one another, but in other examples not illustrated, they can also be implemented in parallel or in another order, for example 208 then 212 and 210, or 210 then 212 and 208, or even 212 then 208 and 210. To maximize control by the manufacturer, for step 214 to be implemented, all steps 208, 210, and 212 should preferably be validated (branch Y).

In a non-illustrated example of the implementation of FIGS. 2 and 3, all or some of the option bytes User_OB2 resulting from the update of option bytes User_OB1, are reset, after a given time, to their initial value User_OB1 prior to their update. This allows the manufacturer, for example, to authorize an upgrade of the microcontroller configuration for a given time, in the manner of temporary licenses.

Various embodiments and variants have been described. Those skilled in the art will understand that certain features of these embodiments can be combined and other variants will readily occur to those skilled in the art. In particular, the value chosen for the first signal RSSACCDIS may be different from 0xA3, as long as it cannot be reached by a simple disturbance, for example by using a high-entropy value.

Finally, the practical implementation of the embodiments and variants described herein is within the capabilities of those skilled in the art based on the functional description provided hereinabove. In particular, concerning steps 210 and 212, authorization to modify the register of option bytes User_OB1 can be given even if the program ROT run at startup does not originate from the manufacturer, as long as it is secured by the manufacturer.

What is claimed is:

1. A method for configuring a microcontroller, comprising:
authorizing modification of a register containing microcontroller configuration option bytes in response to:
a first stage of a start-up program of the microcontroller, secured by a microcontroller manufacturer, being run; and
an access authorization level of a microcontroller program corresponding to a microcontroller manufacturing state, or to a state in which only the first stage of the start-up program of the microcontroller is authorized.

2. The method according to claim 1, further comprising:
reading, by the first stage of the start-up program, a first program secured by the microcontroller manufacturer; and
in response to the access authorization level having been validated, modifying a value of one or more of the configuration option bytes in the register according to instructions included in the first program.

3. The method according to claim 1, wherein the first stage of the start-up program is stored in a FLASH-type system memory of the microcontroller.

4. The method according to claim 3, further comprising, in response to the first stage of the start-up program being run, setting a first signal to a given value.

5. The method according to claim 4, further comprising setting the first signal to a value of 0xA3 in response to the first stage of the start-up program being run.

6. The method according to claim 1, wherein the access authorization level of the microcontroller program is given by a monotonically increasing counter.

7. The method according to claim 6, wherein a zero value of the monotonically increasing counter corresponds to the microcontroller manufacturing state.

8. The method according to claim 6, wherein a value 1 of the monotonically increasing counter corresponds to the state in which only the first stage of the start-up program is authorized.

9. The method according to claim 7, further comprising:
setting, in response to the first stage of the start-up program being run, a first signal to a given value; and
authorizing, in response to the first signal having the given value and the monotonically increasing counter having the value zero or 1, modification of the configuration option bytes.

10. The method according to claim 2, wherein the first stage of the start-up program of the microcontroller and the first program are secured with one or more security keys.

11. The method according to claim 1, wherein:
the register comprises several categories of different configuration option bytes for controlling an activation or a deactivation of a same configuration characteristic of the microcontroller;
a first category of configuration option bytes is writable only during a production phase by the microcontroller manufacturer; and
a second category of configuration option bytes is writable, after production, in response to the access authorization level being validated.

12. The method according to claim 2, further comprising, prior to the authorizing, loading the first program into a download memory of the microcontroller.

13. The method according to claim 12, further comprising, after loading the first program, resetting the microcontroller.

14. The method according to claim 2, further comprising resetting the one or more configuration option byte values that have been modified, after a given time, to their pre-modification values.

15. A microcontroller, comprising:
a configuration option byte register;
wherein the microcontroller is configured to:
authorize modification of the configuration option byte register in response to:
a first stage of a start-up program of the microcontroller, secured by a microcontroller manufacturer, being run; and
an access authorization level of a microcontroller program corresponding to a microcontroller manufacturing state, or to a state in which only the first stage of the start-up program of the microcontroller is authorized.

16. The microcontroller according to claim 15, wherein a first program, secured by the microcontroller manufacturer, is read by the first stage of the start-up program and, in response to the authorization having been validated, a value of one or more configuration option bytes in the configuration option byte register is modified according to instructions included in the first program.

17. The microcontroller according to claim 16, wherein the first stage of the start-up program of the microcontroller and the first program are secured with one or more security keys.

18. The microcontroller according to claim 15, wherein the first stage of the start-up program is stored in a FLASH-type system memory of the microcontroller.

19. The microcontroller according to claim 15, wherein the access authorization level of the microcontroller is given by a monotonically increasing counter.

20. The microcontroller according to claim 15, wherein:
the configuration option byte register comprises several categories of different configuration option bytes for controlling an activation or a deactivation of a same configuration characteristic of the microcontroller;
a first category of configuration option bytes is writable only during a production phase by the microcontroller manufacturer; and
a second category of configuration option bytes is writable, after production, in response to the authorization being validated.
